(19) United States
(12) Patent Application Publication
(10) Pub. No.: US 2019/0086670 A1
(43) Pub. Date: Mar. 21, 2019

(54) HEAD-MOUNTED DISPLAY AND IMAGE DISPLAY DEVICE

(71) Applicant: SEIKO EPSON CORPORATION, Tokyo (JP)

(72) Inventor: Daisuke ISHIDA, Chino-shi (JP)

(73) Assignee: SEIKO EPSON CORPORATION, Tokyo (JP)

(21) Appl. No.: 16/135,029

(22) Filed: Sep. 19, 2018

(30) Foreign Application Priority Data
Sep. 20, 2017 (JP) 2017-179867

(51) Int. Cl. G02B 27/01; G02B 27/14; H01S 3/00; G02B 27/10

(52) U.S. Cl. CPC G02B 27/0172; G02B 27/1053; H01S 3/005; G02B 27/141

(57) ABSTRACT

A light beam combiner and splitter included in a head-mounted display serving as an image display device, when combining and splitting light beams R, G, and B of respective colors from laser sources, combines first components of light R1, G1, and B1 with small amounts of light amongst components of separated light beams of respective colors, thus generating modulated light. This attenuates the laser beams emitted from the light source section.

The present application is based on and claims priority from JP Application Serial Number 2017-179867, filed Sep. 20, 2017, the disclosure of which is hereby incorporated by reference herein in its entirety.

### BACKGROUND

### 1. Technical Field

The disclosure relates to a head-mounted display and an image display device.

### 2. Related Art

As an image display technology for head-mounted displays (HMDs), there is a known image display device that irradiates the retina of the eye directly with a laser beam to allow a user (or an observer) to view an image (for example, refer to JP-A-2005-55780). However, the retina-scanning head-mounted display using a laser beam described above needs to have reduced energy of light, with which the retina is to be irradiated, to protect the eye. However, in terms of image formation, to maintain stable laser oscillation and ensure a sufficient range of gradation levels in a laser source or a light emitting source, it is expected for currently used laser sources to have at least certain power output or greater (e.g., several tens to several hundreds of milliwatts). With a laser source having a power output of several tens to several hundreds of milliwatts, since a very small amount of component of image light (e.g., 0.1% of the total power output or less) alone is to be used in order to protect the eye, most of components are cut off before reaching the eye. For example, JP-A-2005-055780 discloses a neutral density filter serving as means for reducing the energy of light that reaches the eye.

However, additionally providing such HMDs or image display devices with a neutral density filter as described above to use a laser light source may result in an increased number of parts and accordingly make it hard to downsize the device.

Note that it is also known that a filter for light attenuation, which has a different purpose from the light attenuation for allowing the retina of the eye to be irradiated directly with a laser beam as described above, is used in a laser light source for a projector or a head-up display (HUD) (for example, refer to JP-A-2017-076086 and JP-A-2015-022251). JP-A-2015-022251 also discloses a light intensity attenuator that transmits or reflects a blue light beam of color light beams to attenuate the blue light beam more than the other color light beams, in order to represent uniform white color in a display device (a mixed-color display).

### SUMMARY

An object of the disclosure is to provide a head-mounted display and an image display device which can attenuate a laser beam without any additional parts and make the device small.

A head-mounted display according to the disclosure includes a plurality of laser sources configured to emit light beams of respective colors, a light beam combiner and splitter configured to split and combine the light beams of respective colors from the plurality of laser sources, and a light scanner configured to perform scanning with a light beam from the light beam combiner and splitter. The light beam combiner and splitter is configured to combine small amounts of components of light amongst components of separated light beams of respective colors and outputs the components that are combined to the light scanner.

In the head-mounted display, when combining and splitting the light beams of respective colors emitted from the laser sources, the light beam combiner and splitter that is a member constituting a light source section for forming image light combines small amounts of components of light amongst components of the separated light beams of respective colors, thus allowing the laser beams emitted from the light source section to be attenuated. Therefore, attenuation of a laser beam is performed, for example, at a position downstream from a light source device on an optical path of the light source device or the like, without any additional parts for the attenuation, and thus a small-sized device can be provided.

In a specific aspect of the disclosure, the light beam combiner and splitter may be configured to separate a small amount of component of light from at least one color light beam of the light beams of respective colors through reflection. With the configuration in which a small amount of component of light is separated through reflection, even in a case where a member for the reflection of the light beam combiner and splitter breaks down and does not work, for example, a component with high energy is prevented from traveling to a target to which the component with a small amount of light is to travel originally, that is, to the eye of an observer (a wearer or a user).

In another aspect of the disclosure, at least one of the plurality of laser sources may be different in a light emission direction from the other laser sources. In this case, the light beams emitted from two laser sources different in the light emission direction from each other can be combined by a single member (e.g., a single dichroic mirror), and thus the number of parts of the light beam combiner and splitter can be reduced.

In still another aspect of the disclosure, the light beam combiner and splitter may include a first dichroic mirror configured to combine a first color light beam and a second color light beam from the plurality of laser sources, and a second dichroic mirror configured to combine a light beam traveling via the first dichroic mirror and a third color light beam, and separate large amounts of component of light from components of the light beams of respective colors. In this case, the first and second dichroic mirrors combine the first to third color light beams, which allows full-color image display. In addition, the second dichroic mirror separates large amounts of components of light from components of the light beams of respective colors, and thus attenuation of a laser beam can be performed without any additional parts for the attenuation.

In still another aspect of the disclosure, the head-mounted display may further include a photodetector configured to receive large amounts of components of light amongst components of the light beams of respective colors separated by the light beam combiner and splitter. With the configuration in which the photodetector receives large amounts of components of light, the effect of noise generated when the photodetectors receive light is reduced and the photodetector performs stable detection, thus, the amount of light can be properly adjusted in the light source section.

In still another aspect of the disclosure, the light beam combiner and splitter may include a plurality of light beam splitters provided corresponding to the plurality of laser sources, respectively, and to light emission directions of the respective laser sources. With that configuration, the plurality of light beam splitters can split the light beam of each color into a small amount of component of light and a large amount of component of light.

In still another aspect of the disclosure, the plurality of light beam splitters may be configured to reflect a small amount of component of light and transmit a large amount of component of light for each color to perform separation. With the configuration in which for each color, a small amount of component of light is separated through reflection and a large amount of component of light is separated through transmission, even in a case where any one of the light beam splitters breaks down and does not work, a large amount of component of light with high energy is prevented from traveling to a target to which the component with a small amount of light is to travel originally, that is, to the eye of an observer (a wearer or a user), and thus safety can be enhanced.

In still another aspect of the disclosure, the head-mounted display may further include a plurality of photodetectors for respective colors, the plurality of photodetectors being configured to receive a large amount of component of light from light beams of respective colors traveling via the plurality of light beam splitters. With that configuration, the plurality of photodetectors for the respective colors allow output states of the laser sources for the respective colors to be confirmed, and thus the amount of light can be adjusted in the light source section. In particular, with the configuration in which each photodetector receives a large amount of component of light, the effect of noise generated when the photodetectors receive light is reduced and the photodetector performs stable detection, thus, the amount of light can be properly adjusted for each color in the light source section.

In still another aspect of the disclosure, the light beam combiner and splitter may be configured to guide small amounts of components of light from light beams of respective colors traveling via the plurality of light beam splitters to an identical optical path to combine the small amounts of components of light. With that configuration, small amounts of components of light from the light beams of respective colors can be combined, and the combined components can be surely output to the light scanner.

An image display device according to the disclosure includes a plurality of laser sources configured to emit light beams of respective colors, a light beam combiner and splitter configured to split and combine the light beams of respective colors from the plurality of laser sources through reflection and transmission, and a light scanner configured to perform scanning with a light beam from the light beam combiner and splitter. The light beam combiner and splitter is configured to combine small amounts of components of light amongst components of separated light beams of respective colors and outputs the components that are combined to the light scanner as image light.

In the image display device, when combining and splitting the light beams of respective colors emitted from the laser sources, the light beam combiner and splitter that is a member constituting a light source section for forming image light combines small amounts of components of light amongst components of the separated light beams of respective colors, thus allowing the laser beam emitted from the light source section to be attenuated. Therefore, attenuation of a laser beam is performed, for example, at a position downstream from a light source device on an optical path of the light source device or the like, without any additional parts for the attenuation, and thus a small-sized device can be provided.

### BRIEF DESCRIPTION OF THE DRAWINGS

Embodiments of the disclosure will be described with reference to the accompanying drawings, wherein like numbers reference like elements.

FIG. 1 conceptually illustrates a head-mounted display according to First Exemplary Embodiment.

FIG. 2 illustrates a light source device included in a head-mounted display.

FIG. 3 illustrates graphs of wavelength characteristics of dichroic mirrors.

FIG. 4 illustrates an optical path of the light source device illustrated in FIG. 2.

FIG. 5 illustrates a light source device included in a head-mounted display according to Second Exemplary Embodiment.

FIG. 6 illustrates graphs of wavelength characteristics of dichroic mirrors.

FIG. 7 illustrates an optical path of the light source device illustrated in FIG. 5.

FIG. 8 illustrates a modified example of a method of light detection.

### DESCRIPTION OF EXEMPLARY EMBODIMENTS

### First Exemplary Embodiment

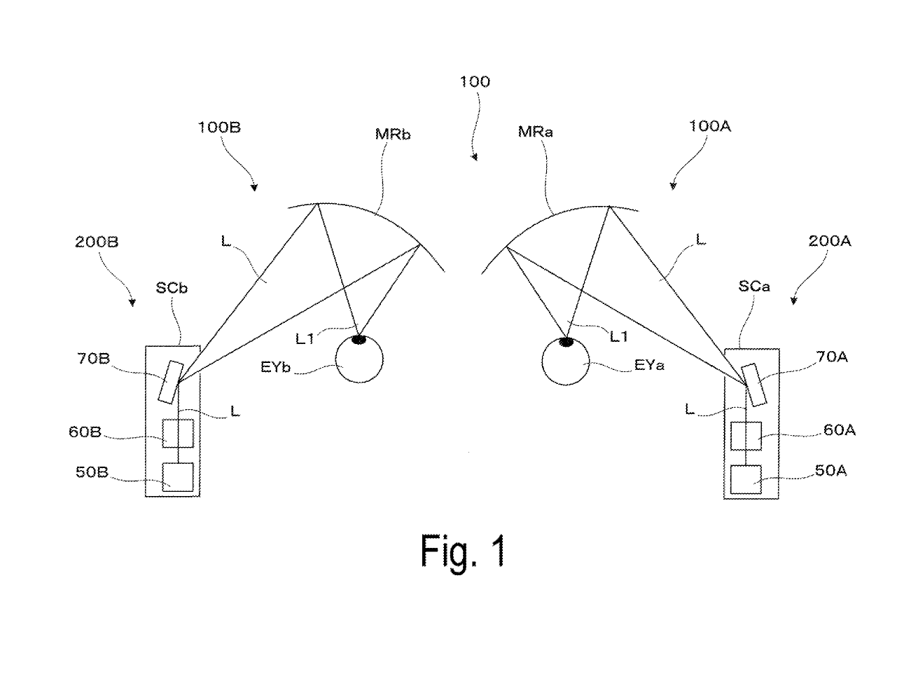

An example of a head-mounted display (HMD) according to First Exemplary Embodiment will be described in detail below with reference to FIG. 1 and the like.

As conceptually illustrated in FIG. 1, a head-mounted display 100 of First Exemplary Embodiment is a head-mounted display device to be mounted on the head of an observer in use, and is also an image display device that allows the observer or a user to view image light. As an example, the head-mounted display 100 is configured to allow the observer to view a superimposed image of an image of image light and an outside image.

As illustrated in FIG. 1, the head-mounted display 100 includes a symmetric pair of a right-eye display unit 100A and a left-eye display unit 100B in a left-and-right direction. Note that the display units 100A and 100B are each supported by and fixed to, for example, a frame (not illustrated) so as to be mounted on the head of the observer.

As elements for the right eye, the display unit 100A includes an image light generator 200A and a reflecting mirror MRa. In the state where the head-mounted display 100 is worn, the image light generator 200A is disposed on the right side of the head of the observer, and the reflecting mirror MRa is disposed in front of the eye (forward of the right eye).

The image light generator 200A includes a light source device 50A, a condenser lens 60A, and a light scanner 70A, which are stored in a housing SCa.

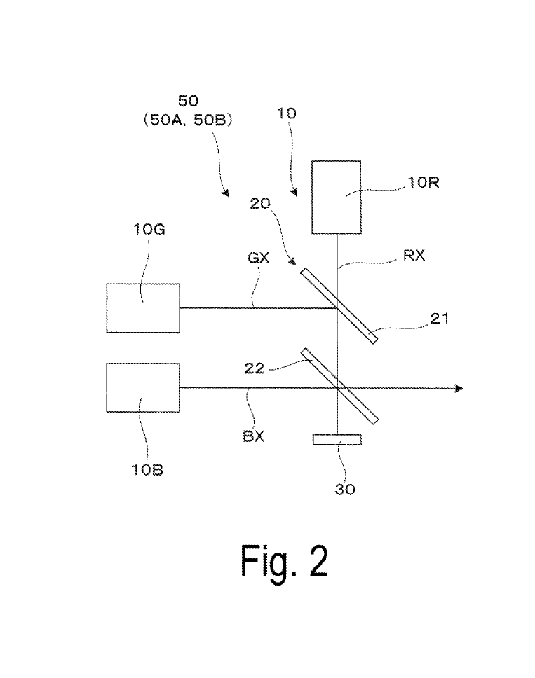

The light source device 50A combines light beams of a plurality of colors with different wavelengths to generate and output modulated light that is to be image light. A detailed configuration of the light source device 50A will be described later with reference to FIG. 2 and the like. In First Exemplary Embodiment, the light source device 50A is configured to combine small amounts of components of light amongst components of generated light beams of respective colors to output the combined components to the light scanner 70A.

The condenser lens 60A is provided on the light emission side of the light source device 50A, and is a lens for adjusting the modulated light output from the light source device 50A to make the modulated light travel to the light scanner 70A in a certain state.

The light scanner 70A is an optical scanner that spatially (two-dimensionally) scans the reflecting mirror MRa with the modulated light output from the light source device 50A and passing through the condenser lens 60A.

Of the elements for the right eye, the reflecting mirror MRa is formed from, for example, an aspherical half mirror. The reflecting mirror MRa, which is disposed in front of the eye of the observer, has a size large enough to cover the right eye EYa of the observer, and has a function to make the modulated light, with which the light scanner 70A performs scanning, enter a right eye EYa of the observer as image light. In other words, the reflecting mirror MRa is a deflector that has a function to deflect the modulated light to the eye of the observer as image light. Note that the reflecting mirror MRa, which is formed from a half mirror, enables the head-mounted display 100 to be provided as a see-through type that allows the observer to view not only image light but also an outside image. Furthermore, the reflecting mirror MRa may be formed from a holographic element (holographic mirror) which is a type of diffraction grating. The holographic element is a semi-transmissive film having characteristics that diffract light within a specific wavelength range and transmit light within the other ranges. That configuration also enables the head-mounted display 100 to be provided as a see-through type.

In the right-eye display unit 100A, a path in which light is emitted from the light source device 50A and reaches the right eye EYa of the observer is simply described below. First, the light source device 50A generates and outputs modulated light L modulated on the basis of an image signal. Next, the condenser lens 60A guides the modulated light L from the light source device 50A to the light scanner 70A, and the light scanner 70A spatially (two-dimensionally) scans the reflecting mirror MRa with the modulated light L. The reflecting mirror MRa scanned with the modulated light L generates image light L1, and the image light L1 is guided to the right eye EYa of the observer.

Likewise, the left-eye display unit 100B includes an image light generator 200B and a reflecting mirror MRb. In the state where the head-mounted display 100 is worn, the image light generator 200B is disposed on the left side of the head of the observer, and the reflecting mirror MRb is disposed in front of the eye (forward of the left eye). The image light generator 200B includes a light source device 50B, a condenser lens 60B, and a light scanner 70B, which are stored in a housing SCb. Note that a detailed description of the respective elements of the left-eye display unit 100B is omitted because it is one of the symmetric pair and has the same functions as the right-eye display unit 100A; for example, the light source device 50B has the same configuration and functions as the light source device 50A. As in the case of the right-eye display unit 100A, in the left-eye display unit 100B, light emitted from the light source device 50B reaches a left eye EYb of the observer.

The configuration as described above allows the observer to view an image according to an image signal. Note that the head-mounted display 100 of First Exemplary Embodiment is a binocular HMD; however the head-mounted display 100 may be a monocular HMD. Specifically, the head-mounted display 100 may include one of the display units 100A and 100B.

In the case where the head-mounted display 100 as described above is configured as a retina-scanning type using a laser light source, the energy of light with which the retina is to be irradiated needs to be reduced for safety reasons (e.g., the energy is reduced down to approximately several microwatts when the light enters the eye). In this respect, for example, a neutral density filter (ND filter) may be provided in the optical path to sufficiently attenuate the light. However, such a configuration may result in an increased number of parts and accordingly make it hard to downsize the device. In addition, this configuration may result in increased weight and cost.

On the other hand, in terms of image formation, to maintain stable laser oscillation and ensure a sufficient range of gradation levels in a laser source or a light emitting source, it is expected for currently used laser sources to have at least certain power output or greater (e.g., several tens to several hundreds of milliwatts). Specifically, in a case of a laser source having a power output of several tens to several hundreds of milliwatts, since a very small amount of component of image light (e.g., 0.1% of the total power output or less) alone is to be used to protect the eye, most of components may be cut off before reaching the eye.

Accordingly, in First Exemplary Embodiment, each of the light source devices 50A and 50B has a function of attenuating light as well as a function of generating and emitting modulated light, so as to efficiently attenuate a laser beam without any additional parts and make the device small.

A configuration example of a light source device 50 corresponding to the light source device 50A or the light source device 50B illustrated in FIG. 1 will be described in detail below with reference to FIG. 2 and the like.

As described in FIG. 2, the light source device 50 (50A, 50B) includes a light source 10 including three laser sources 10R, 10G, and 10B serving as a plurality of laser sources, a light beam combiner and splitter 20 including a first dichroic mirror 21 and a second dichroic mirror 22 serving as two dichroic mirrors, and a photodetector 30 configured to detect light emission states of the laser sources 10R, 10G, and 10B.

In the light source 10, the laser source 10R emits a red light beam as a first color light beam, the laser source 10G emits a green light beam as a second color light beam, and the laser source 10B emits a blue light beam as a third color light beam. The light beams of three colors make a full-color image displayed. Note that as each of the laser sources 10R, 10G, and 10B, a laser diode can be used, for example. The laser sources 10R, 10G, and 10B, their detailed description being omitted, are separately drive-controlled through drive circuits respectively provided in the laser sources, under control of a controller, to generate modulated light modulated on the basis of an image signal. Three light beams emitted from the laser sources 10R, 10G, and 10B enter the light beam combiner and splitter 20. As an example, the light source 10G and the laser source 10B are arranged in parallel to have a same light emission direction, and the laser source 10R is arranged in light emission direction different from light emission directions of the laser source 10G and the laser source 10B. Specifically, the light emission direction of the laser source 10R and the light emission direction of the laser source 10G are perpendicular to each other. Furthermore, the first dichroic mirror 21 of the light beam combiner and splitter 20 is disposed at the intersection of these color light beams with its surface inclined at 45° with respect to both light emission directions.

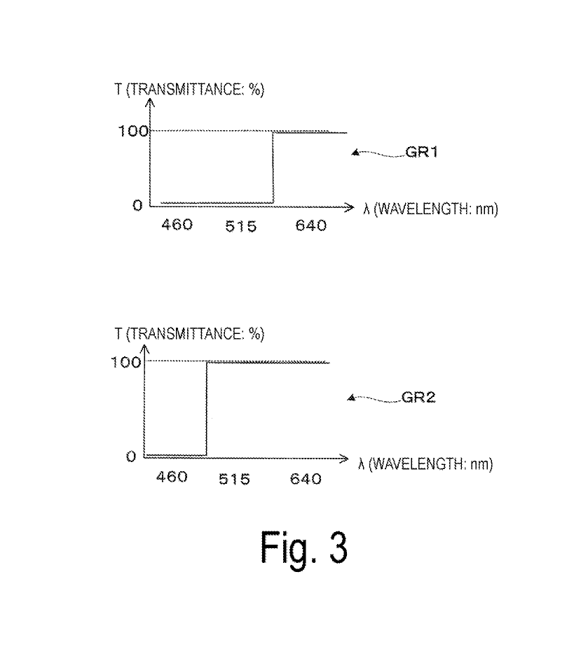

The light beam combiner and splitter 20 combines and splits the light beams of the respective colors emitted from the plurality of laser sources 10R, 10G, and 10B. As described above, the first dichroic mirror 21 of the light beam combiner and splitter 20 is disposed at the intersection of an emission axis RX of the red light beam emitted from the laser source 10R and an emission axis GX of the green light beam emitted from the laser source 10G with its surface inclined at 45° with respect to both axes. The first dichroic mirror 21 has such wavelength characteristics as a graph GR1 represented in FIG. 3. Note that in the graph GR1, the horizontal axis represents visible light wavelength λ (unit: nm), and the vertical axis represents transmittance T (%). As can be seen from the graph GR1, the first dichroic mirror 21 has functions of transmitting most of components within the wavelength range of red light (around 640 nm) in longer wavelengths and reflect most of components within the wavelength range of green light shorter than the wavelength range of red light. Accordingly, the first dichroic mirror 21 transmits the red light beam emitted from the laser source 10R and reflects the green light beam emitted from the laser source 10G, thus combining these light beams.

On the other hand, the second dichroic mirror 22 of the light beam combiner and splitter 20 is disposed downstream from the first dichroic mirror 21 on the optical path at the intersection of the emission axis RX of the combined light of the red and green light beams traveling via the first dichroic mirror 21 and an emission axis BX of the blue light beam emitted from the laser source 10B with its surface inclined at 45° with respect to both axes, thus combining these light beams. The second dichroic mirror 22 has such wavelength characteristics as a graph GR2 represented in FIG. 3. As can be seen from the graph GR2, the second dichroic mirror 22 has functions of transmitting most of components within the wavelength range of red and green light in longer wavelengths, and reflect most of components within the wavelength range of blue light (around 460 nm) shorter than the wavelength range of green light. In another point of view, the second dichroic mirror 22 separates and combines part of components of light beam of each color. Specifically, the second dichroic mirror 22 separates very small components, that is, small amounts of components of light from components of the red and green light beams through reflection, separates a very small component, that is, a small amount of component of light from components of the blue light beam through transmission, and combines these separated components to output the combined components. On the other hand, the second dichroic mirror 22 separates most of components, that is, large amounts of components of light, from components of the red and the green light beams through transmission, and separates most of component, that is, a large amount of component of light, from components of the blue light beam through reflection. These separated components travel to the photodetector 30.

The photodetector 30 is a device that receives large amounts of components of light amongst the components of light beams of the respective colors separated by the light beam combiner and splitter 20 to measure the intensity of the received components of light. In other words, the photodetector 30 is a light receiving element (photodetector). As the photodetector 30, for example, an RGB color sensor/photodetector may be used. This type of photodetector makes it possible to detect the component of light for each color which travels via the light beam combiner and splitter 20 and is incident on the photodetector.

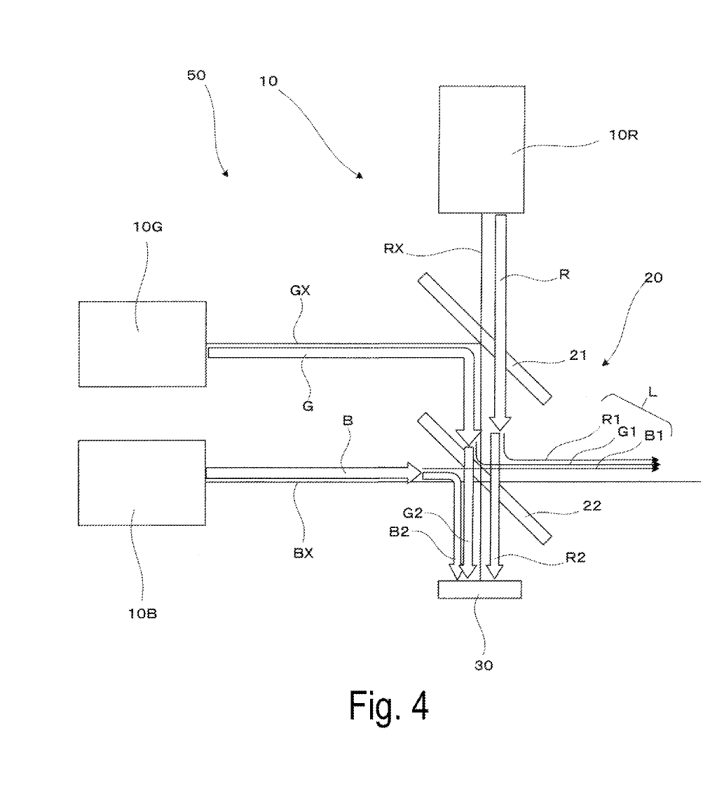

A detailed description is given below with reference to FIG. 4 of generation of modulated light to be image light through splitting and combining of the light beams of the respective colors, processing of unwanted light due to light attenuation, and the like in the light source device 50.

To begin with, in the light source 10, an optical path of a red light beam R is described that is the first color light beam and emitted from the laser source 10R. The red light beam R emitted from the laser source 10R enters the first dichroic mirror 21. Most of the red light beam R passes through the first dichroic mirror 21 because of the characteristics of the first dichroic mirror 21. Furthermore, the red light beam R passing through the first dichroic mirror 21 enters the second dichroic mirror 22. While most of the red light beam R passes through the second dichroic mirror 22, a very small partial component of the red light beam R alone is reflected by the second dichroic mirror 22 because of the characteristics of the second dichroic mirror 22. In FIG. 4, a very small component reflected by the second dichroic mirror 22, that is, a small amount of component of light, is represented as a first component of light R1, and the remaining most of component passing through the second dichroic mirror 22, that is, a large amount of component of light, is represented as a second component of light R2.

Next, in the light source 10, an optical path of a green light beam G is described that is the second color light beam and emitted from the laser source 10G. The green light beam G emitted from the laser source 10G enters the first dichroic mirror 21. Most of the green light beam G is reflected by the first dichroic mirror 21 because of the characteristics of the first dichroic mirror 21. The green light beam G reflected by the first dichroic mirror 21 enters the second dichroic mirror 22. While most of the green light beam G passes through the second dichroic mirror 22, a very small partial component of the green light beam G is reflected by the second dichroic mirror 22 because of the characteristics of the second dichroic mirror 22. In FIG. 4, a very small component reflected by the second dichroic mirror 22, that is, a small amount of component of light is represented as a first component of light G1, and the remaining most of component passing through the second dichroic mirror 22, that is, a large amount of component of light, is represented as a second component of light G2.

Lastly, in the light source 10, an optical path of a blue light beam B is described that is the third color light beam and emitted from the laser source 10B. The blue light beam B emitted from the laser source 10B enters the second dichroic mirror 22. While most of the blue light beam B is reflected by the second dichroic mirror 22, a very small partial component of the blue light beam B passes through the second dichroic mirror 22 because of the characteristics of the second dichroic mirror 22. In FIG. 4, a very small component passing through the second dichroic mirror 22, that is, a small amount of component of light, is represented as a first component of light B1, and the remaining most of component reflected by the second dichroic mirror 22, that is, a large amount of component of light, is represented as a second component of light B2.

Of the light beams of the colors, R, G, and B, the first components of light R1, G1, and B1 with small amounts of light are used for image rendering. In other words, these components are output from the light source device 50 as components of the modulated light L to be image light (refer to FIG. 1).

Here, the following describes a summary of the functions of the light beam combiner and splitter 20 described above. The light beam combiner and splitter 20 combines the red light beam R and the green light beam G emitted from the respective laser sources 10R and 10G at the first dichroic mirror 21, and combines the combined light beam of the red light beam R and the green light beam G traveling via the first dichroic mirror 21 and the blue light beam B emitted from the laser source 10B at the second dichroic mirror 22, thus generating the modulated light L. In addition, since the second components of light are unwanted for forming image light, the light beam combiner and splitter 20 separates the second components of light R2, G2, and B2 from the modulated light L at the second dichroic mirror 22, the second components being the large amounts of components of light amongst the components of light beams of the respective colors.

The second components of light R2, G2, and B2, which are unavailable for image light, enter the photodetector 30 disposed at a position where the components of light passing through or reflected by the second dichroic mirror 22 reach. Accordingly, the second components of light R2, G2, and B2 are used for measuring amounts of the components of light.

As described above, the photodetector 30 is constructed from, for example, an RGB color sensor/photodetector or the like. The photodetector 30 includes a color filter configured to transmit light having a specific wavelength alone on its surface. Specifically, filters with different characteristics for R, G, and, B are provided on the photodetector 30. With that configuration, even when components of light R2, G2, and B2 with three different wavelengths simultaneously enter the photodetector 30, the photodetector 30 separately measures the amounts of the respective color light beams. The detection result of the photodetector 30 may be used for Automatic Power Control (APC). Specifically, while emission powers for the three color light beams are constantly monitored through the single photodetector 30, the APC controls variations of the emission powers due to temperatures and the like. The configuration described above effectively utilizes the components of light to be attenuated in forming the image light, that is, the second components of light R2, G2, and B2, which are components to be eliminated as unwanted light. In a comparative example that an ND filter is provided on an optical path to attenuate light, such unwanted light is not supposed to effectively be utilized and will be eliminated without being used. In contrast, in a case of the configuration for the effective utilization as described above, since the photodetector 30 receives and detects the second components of light R2, G2, and B2, which are large amounts of components of light, the amplitude of the detection signal increases in response to the received light, the effect of noise generated when the photodetectors receive light is reduced accordingly, and the photodetector 30 performs stable detection, thus, the amount of light can be properly adjusted in the light source section.

As described above, in the head-mounted display 100 serving as the image display device according to First Exemplary Embodiment, when combining and splitting the light beams R, G, and B of the respective colors emitted from the laser sources 10R, 10G, and 10B, the light beam combiner and splitter 20 that is a member constituting the light source section for forming image light combines the first components of light R1, G1, and B1 with small amounts of light amongst components of the separated light beams of the respective colors, thus allowing the laser beams emitted from the light source section to be attenuated. Therefore, attenuation of a laser beam can be performed, for example, at a position downstream from the light source device 50 on an optical path of the light source device 50 or the like, without any additional parts for the attenuation, and thus a small-sized device can be provided.

In the configuration described above, from at least the green light beam G, the first dichroic mirror 21 and the second dichroic mirror 22 of the light beam combiner and splitter 20 separates the first component of light G1 with a small amount of light through reflection. In other words, a component to be image light traveling to the eye of the observer is guided by reflection. This prevents a component with high energy of the green light beam G from traveling to the eye of the observer, even in a case where the first dichroic mirror 21 or the second dichroic mirror 22 of the light beam combiner and splitter 20 breaks down and does not work, for example. Likewise, as to the red light beam R, the second dichroic mirror 22 guides the first component of light R1 by reflection, thus preventing a high energy component from traveling to the eye. Note that for a case that the second dichroic mirror 22 breaks down, an additional device and the like may be provided to shut out the blue light beam B emitted from the laser source 10B in response to detection of a sensor for monitoring the second dichroic mirror 22 or detection of any failure.

### Second Exemplary Embodiment

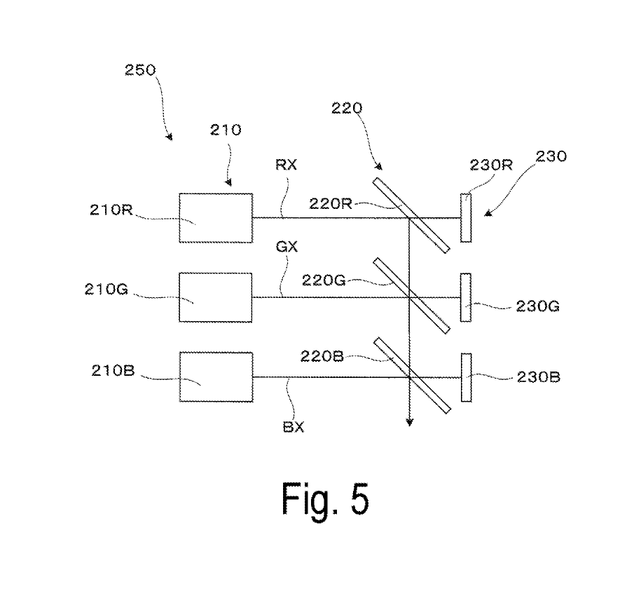

A head-mounted display device according to Second Exemplary Embodiment will be described in detail below with reference to FIG. 5 and the like. Second Exemplary Embodiment is a modified example of First Exemplary Embodiment, and has almost the same configuration as a configuration in First Exemplary Embodiment except for the light source device. Accordingly, drawings and descriptions for the whole configuration and also descriptions for elements except for the light source device are omitted.

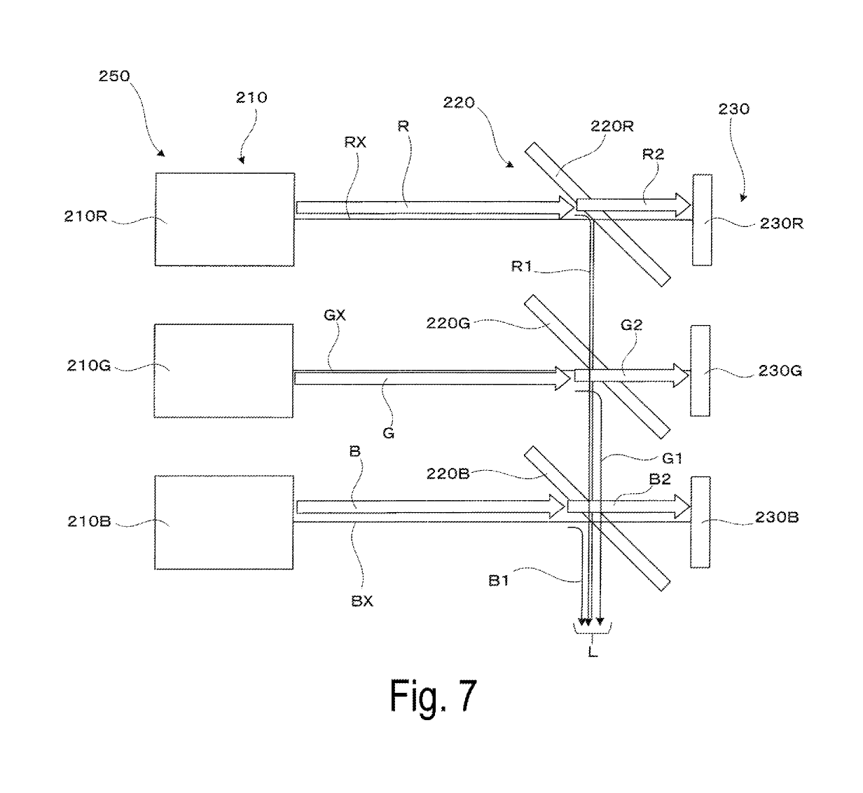

As illustrated in FIG. 5, a configuration example of a light source device included in the head-mounted display according to Second Exemplary Embodiment will be described in detail below. Note that FIG. 5 corresponds to FIG. 2, and FIG. 7 corresponds to FIG. 4.

To begin with, as described in FIG. 5, a light source device 250 includes a light source 210 including three laser sources 210R, 210G, and 210B serving as a plurality of laser sources, a light beam combiner and splitter 220 including a first light beam splitter 220R, a second light beam splitter 220G, and a third light beam splitter 220B, which serve as three light beam splitters and correspond to the three laser sources 210R, 210G, and 210B, respectively, and an optical detection device 230 including three photodetectors 230R, 230G, and 230B, which serve as a plurality of photodetectors and are configured to detect light emission states of the laser sources 210R, 210G, and 210B, respectively.

In the light source 210, the laser source 210R emits a red light beam as the first color light beam, the laser source 210G emits a green light beam as the second color light beam, and the laser source 210B emits a blue light beam as the third color light beam. Three light beams emitted from the laser sources 210R, 210G, and 210B enter the three light beam splitters 220R, 220G, and 220B, respectively, which constitute the light beam combiner and splitter 220. As an example, the three laser sources 210R, 210G, and 210B are arranged in parallel to have a same light emission direction. Furthermore, the first light beam splitter 220R, the second light beam splitter 220G, and the third light beam splitter 220B are disposed corresponding to the respective color light beams with their surface inclined at 45° with respect to the light emission direction.

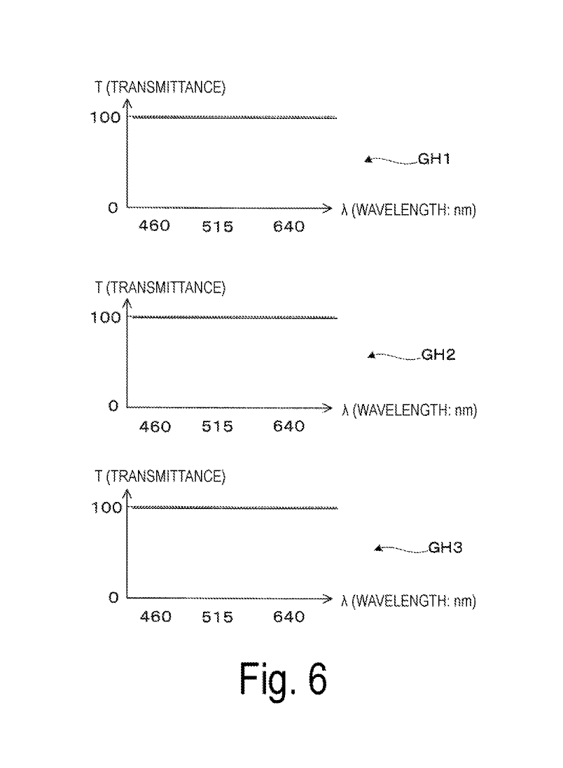

The light beam combiner and splitter 220 combines and splits the light beams of the respective colors emitted from the plurality of laser sources 210R, 210G, and 210B. In the light beam combiner and splitter 220, the first light beam splitter 220R is a mirror member disposed corresponding to the laser source 210R in the light emission direction of the laser source 210R configured to emit the red light beam as the first color light beam. Specifically, as illustrated in FIG. 5, the first light beam splitter 220R is inclined at 45° with respect to the emission axis RX of the red light beam. The first light beam splitter 220R has such wavelength characteristics as a graph GH1 represented in FIG. 6. Note that in the graph GH1, the horizontal axis represents visible light wavelength λ (unit: nm), and the vertical axis represents transmittance T (%). As can be seen from the graph GH1, the first light beam splitter 220R serving the mirror member has functions of transmitting most of components within the whole wavelength range of visible light and reflect a very small component.

Likewise, in the light beam combiner and splitter 220, the second light beam splitter 220G is a mirror member disposed corresponding to the laser source 210G in the light emission direction of the laser source 210G configured to emit the green light beam as the second color light beam. Specifically, as illustrated in FIG. 5, the second light beam splitter 220G is inclined at 45° with respect to the emission axis GX of the green light beam. As can be seen from a graph GH2 illustrated in FIG. 6, the second light beam splitter 220G also has functions of transmitting most of components within the whole wavelength range of visible light and reflect a very small component.

Likewise, in the light beam combiner and splitter 220, the third light beam splitter 220B is a mirror member disposed corresponding to the laser source 210B in the light emission direction of the laser source 210B configured to emit the blue light beam as the third color light beam. Specifically, as illustrated in FIG. 5, the third light beam splitter 220B is inclined at 45° with respect to the emission axis BX of the blue light beam. As can be seen from a graph GH3 illustrated in FIG. 6, the third light beam splitter 220B also has functions of transmitting most of components within the whole wavelength range of visible light and reflect a very small component.

As illustrated in FIG. 5, in the light beam combiner and splitter 220, the positions of the three light beam splitters 220R, 220G, and 220B are aligned, and thus the components reflected by the light beam splitters 220R, 220G, and the 220B are guide to and combined on an identical optical path. With the configuration described above, the light beam combiner and splitter 220 functions as a unit for performing light combining and light splitting of the light beams of the respective colors. In other words, the light beam combiner and splitter 220 separates and combines part of components of light beam of each color. Specifically, the three light beam splitters 220R, 220G, and 220B separate very small components, that is, small amounts of components of light, from components of the red, green, and blue light beams through reflection, and combines these separated components to output the combined components. On the other hand, the three light beam splitters 220R, 220G, and 220B separate most of components, that is, large amounts of components of light, from components of the red, green, and blue light beams through transmission. These separated components travel to the optical detection device 230.

The optical detection device 230 is a device that receives large amounts of components of light amongst the components of light beams of the respective colors separated by the light beam combiner and splitter 220 to measure the intensity of the received components of light. As the three photodetectors 230R, 230G, and 230B constituting the optical detection device 230, light receiving elements (photodetector) for the respective colors may be used. This configuration makes it possible to separately detect the components of light which pass through the three light beam splitters 220R, 220G, and 220B of the light beam combiner and splitter 220 and enter the photodetectors 230R, 230G, and 230B, for the respective colors.

A detailed description is given with reference to FIG. 7 of generation of modulated light to be image light through splitting and combining of the light beams of the respective colors, processing of unwanted light due to light attenuation, and the like in the light source device 250.

To begin with, in the light source 210, an optical path of the red light beam R, which is the first color light beam, emitted from the laser source 210R is described. The red light beam R emitted from the laser source 210R is split into transmitted light and reflected light by the first light beam splitter 220R serving as a mirror member. Specifically, while most of the red light beam R passes through the first light beam splitter 220R, a very small partial component of the red light beam R is reflected by the first light beam splitter 220R because of the characteristics of the first light beam splitter 220R. In FIG. 7, a very small component reflected by the first light beam splitter 220R, that is, a small amount of component of light is represented as the first component of light R1, and the remaining most of component passing through the first light beam splitter 220R, that is, a large amount of component of light, is represented as the second component of light R2. Note that most of the first component of light R1 passes through the second light beam splitter 220G and the third light beam splitter 220B serving as mirror members because of their characteristics.

Likewise, while most of the green light beam G emitted from the laser source 210G as the second color light beam passes through the second light beam splitter 220G, a very small partial component of the green light beam G is reflected by the second light beam splitter 220G. In FIG. 7, a very small component reflected by the second light beam splitter 220G, that is, a small amount of component of light is represented as the first component of light G1, and the remaining most of component passing through the second light beam splitter 220G, that is, a large amount of component of light, is represented as the second component of light G2. Note that most of the first component of light G1 passes through the third light beam splitter 220B serving as a mirror member because of its characteristics.

Likewise, while most of the blue light beam B emitted from the laser source 210B as the third color light beam passes through the third light beam splitter 220B, a very small partial component of the blue light beam B is reflected by the third light beam splitter 220B. In FIG. 7, a very small component reflected by the third light beam splitter 220B, that is, a small amount of component of light is represented as the first component of light B1, and the remaining most of component passing through the third light beam splitter 220B, that is, a large amount of component of light, is represented as the second component of light B2.

Of the light beams of the colors, R, G, and B, the first components of light R1, G1, and B1 with small amounts of light are output from the light source device 250 as components used for image rendering, that is, components of modulated light to be image light.

Here, the following describes a summary of the functions of the light beam combiner and splitter 220 described above. The light beam combiner and splitter 220 reflects the small amounts of components of light amongst the components of light beams of the respective colors, at the three light beam splitters 220R, 220G, and 220B, and transmits the large amounts of components of light, to separate the second components of light R2, G2, and B2 from the modulated light L because these second components of light are unwanted for forming image light. On the other hand, the light beam combiner and splitter 220 guides the first components of light R1, G1, and B1 with small amounts of light amongst the color light beams traveling via the light beam splitters 220R, 220G, and 220B to an identical optical path to combine the small amounts of components of light, thus generating the modulated light L.

The second components of light R2, G2, and B2, which are not used for image light, enter the three photodetectors 230R, 230G, and 230B, respectively, which constitute the optical detection device 230 and are disposed at positions where the components of light passing through the light beam splitters 220R, 220G, and 220B reach. Accordingly, the second components of light R2, G2, and B2 are used for measuring amounts of the components of light.

As described above, the three photodetectors 230R, 230G, and 230B are constructed from light receiving elements (photodetector) for the respective colors. The photodetectors 230R, 230G, and 230B receive specific wavelengths of colors for R, G, and B, respectively. With that configuration, the photodetectors 230R, 230G, and 230B simultaneously and separately measure the amounts of components of light R2, G2, and B2 with three different wavelengths. The detection results of the photodetectors 230R, 230G, and 230B may be used for APC. Specifically, while emission powers for the three color light beams are constantly monitored, the APC controls variations of the emission powers due to temperatures and the like. The configuration described above effectively utilizes the components of light to be attenuated in forming the image light, that is, the second components of light R2, G2, and B2, which are components to be eliminated as unwanted light. With the configuration for the effective utilization as described above, since the photodetectors 230R, 230G, and 230B receive and detect the second components of light R2, G2, and B2, which are large amounts of components of light, the amplitude of the detection signal increases in response to the received light, the effect of noise generated when the photodetectors receive light is reduced accordingly, and the photodetectors 230R, 230G, and 230B perform stable detection, thus, the amounts of light can be properly adjusted in the light source section.

As described above, in the head-mounted display serving as the image display device according to Second Exemplary Embodiment, when combining and splitting the light beams R, G, and B of the respective colors emitted from the laser sources 210R, 210G, and 210B, the light beam combiner and splitter 220 that is a member constituting the light source section for forming image light combines the first components of light R1, G1, and B1 with small amounts of light amongst components of the separated light beams of respective colors, thus attenuating the laser beams emitted from the light source section. Therefore, attenuation of a laser beam is performed, for example, at a position downstream from the light source device 250 on an optical path of the light source device 250 or the like, without any additional parts for the attenuation, and thus a small-sized device is provided.

In Second Exemplary Embodiment, the mirrors used for color separation or color combination in the light beam combiner and splitter 220 are constructed from mirrors with the same characteristics instead of dichroic mirrors, which can achieve reduced manufacturing costs.

Furthermore, in Second Exemplary Embodiment, the light beam combiner and splitter 220 reflects the small amounts of components of light R1, G1, and B1 to be extracted as image light, and transmits the large amounts of components of light R2, G2, and B2 unwanted for the image light, thus splitting all the color light beams R, G, and B. With that configuration, even in a case where any one of the light beam splitters 220R, 220G, and 220B constituting the light beam combiner and splitter 220 breaks down and does not work, the large amounts of components of light R2, G2, and B2 with high energy are prevented from traveling to a target to which the components with small amounts of components of light are to travel originally, that is, to the eye of the observer, and thus safety can be enhanced.

### Other Exemplary Embodiment

The disclosure is described in accordance with some exemplary embodiments described above, but the disclosure is not limited thereto. Various modifications may be made without departing from the scope of the disclosure.

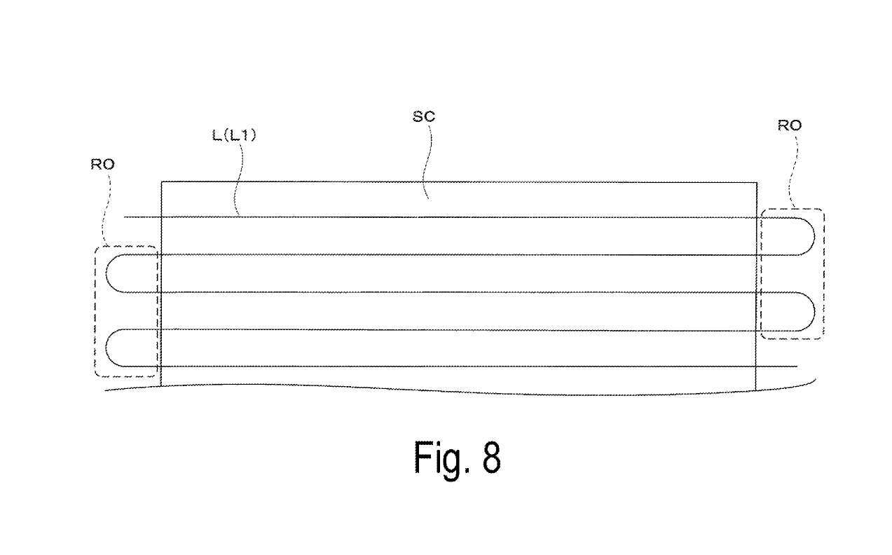

In the configurations described above, the time at which the photodetector or the optical detection device performs optical detection may be determined in various ways. For example, as conceptually illustrated in FIG. 8, a timing of scanning regions RO outside a simulated region SC with a light beam L (L1), corresponding to the timing of image rendering through scanning the eye, may be employed as the time at which the optical detection is performed. In the case where an image is formed in time division, optical detection may be synchronized with the timing of light emission for each color to identify the color when detected.

In the configurations described above, the laser sources for the respective colors are arranged in order of red (R), green (G), and blue (B) from the far side of the light emission positions. However, the arrangement of the laser sources is not limited thereto, and may be in various orders. Furthermore, the location of each laser source is not limited to the examples described above, and may be modified in another way as long as it provides the original function. For example, in Second Exemplary Embodiment, the light emission direction of one or two of the three laser sources illustrated in FIG. 5 or FIG. 7 may be reversed by 180°.

The wavelength characteristics of the dichroic mirror are not limited to that described in the exemplary embodiments, and may be any characteristics as long as small amounts of components of light amongst the components of separated color light beams are combined to be output to the light scanner. For example, in a first exemplary embodiment, in the case where the laser sources 10R, 10G, and 10B are arranged such that one for red (R) and one for blue (B) are swapped, the wavelength characteristics of the first dichroic mirror 21 and the second dichroic mirror 22 are different from those illustrated in FIG. 3 accordingly, so that the same splitting (separating) and combining as those described above can be performed.

Combining the color light beams may be performed in various ways, for example, by combining three-color light beams using an x-prism.

In the configurations described above, the head-mounted display is exemplified as an image display device.

However, the disclosure is not limited thereto, and may be applied to a small projector or an HUD.

What is claimed is:

1. A head-mounted display comprising:
a plurality of laser sources configured to emit light beams of respective colors;
a light beam combiner and splitter configured to split and combine the light beams of respective colors from the plurality of laser sources; and
a light scanner configured to perform scanning with a light beam from the light beam combiner and splitter, wherein
the light beam combiner and splitter is configured to combine small amounts of components of light amongst components of separated light beams of respective colors and outputs the components that are combined to the light scanner.

2. The head-mounted display according to claim 1, wherein
the light beam combiner and splitter is configured to separate a small amount of component of light from at least one color light beam of the light beams of respective colors through reflection.

3. The head-mounted display according to claim 1, wherein
at least one of the plurality of laser sources is different in a light emission direction from the other laser sources.

4. The head-mounted display according to claim 1, wherein
the light beam combiner and splitter includes
a first dichroic mirror configured to combine a first color light beam and a second color light beam from the plurality of laser sources, and
a second dichroic mirror configured to combine a light beam traveling via the first dichroic mirror and a third color light beam, and separate large amounts of component of light from components of the light beams of respective colors.

5. The head-mounted display according to claim 1, further comprising:
a photodetector configured to receive large amounts of components of light amongst components of the light beams of respective colors separated by the light beam combiner and splitter.

6. The head-mounted display according to claim 1, wherein
the light beam combiner and splitter includes a plurality of light beam splitters provided corresponding to the plurality of laser sources, respectively, and to light emission directions of the respective laser sources.

7. The head-mounted display according to claim 6, wherein
the plurality of light beam splitters is configured to reflect a small amount of component of light and transmit a large amount of component of light for each color to perform separation.

8. The head-mounted display according to claim 6, further comprising:
a plurality of photodetectors for respective colors, the plurality of photodetectors being configured to receive a large amount of component of light from light beams of respective colors traveling via the plurality of light beam splitters.

9. The head-mounted display according to claim 6, wherein
the light beam combiner and splitter is configured to guide small amounts of components of light from light beams of respective colors traveling via the plurality of light beam splitters to an identical optical path to combine the small amounts of components of light.

10. An image display device comprising:
a plurality of laser sources configured to emit light beams of respective colors;
a light beam combiner and splitter configured to split and combine the light beams of respective colors from the plurality of laser sources through reflection and transmission; and
a light scanner configured to perform scanning with a light beam from the light beam combiner and splitter, wherein
the light beam combiner and splitter is configured to combine small amounts of components of light amongst components of separated light beams of respective colors and outputs the components that are combined to the light scanner as image light.
